(19) United States
(12) Patent Application Publication
(10) Pub. No.: US 2025/0282493 A1
(43) Pub. Date: Sep. 11, 2025

(54) SYSTEM AND METHOD FOR MANAGING SMART BUILDING FOR INTEGRATED OPERATION OF HETEROGENEOUS MOBILITY DEVICES

(71) Applicants: Hyundai Motor Company, Seoul (KR); Kia Corporation, Seoul (KR)

(72) Inventors: Jang Ho Park, Hwaseong-Si (KR); Choung Hyoung Kim, Anyang-Si (KR); Byoung Yong Lee, Hwaseong-Si (KR)

(21) Appl. No.: 18/904,695

(22) Filed: Oct. 2, 2024

(30) Foreign Application Priority Data
Mar. 8, 2024 (KR) 10-2024-0033329

(51) Int. Cl. B64F 1/36; B64F 1/22; B64F 1/35; B66B 1/34; E04H 6/44

(52) U.S. Cl. CPC B64F 1/368; B64F 1/22; B64F 1/35; B66B 1/3476; E04H 6/44

(57) ABSTRACT

A system comprises a smart building with a vertiport zone and a complex zone; and a managing device. The managing device is configured to: establish movement route information, of the aerial mobility device in the vertiport zone, based on management information associated with a transport object or flight of the aerial mobility device. If the movement route information indicates to move to at least one designated area of the vertiport zone and a charging permission condition is satisfied, the movement route information is set to add a charging site as a layover point. The aerial mobility device is controlled to move to the charging site according to the set movement route information and to be charged. If the movement route information indicates to move to the complex zone, the aerial mobility device is controlled to move to an exit area of the vertiport zone approaching the complex zone.

### CROSS REFERENCE TO RELATED APPLICATION

The present application claims priority to Korean provisional patent application No. 10-2024-0033329, filed Mar. 8, 2024, the entire contents of which are incorporated herein for all purposes by this reference.

### TECHNICAL FIELD

The present disclosure relates to a system and method for managing a smart building for integrated operation of heterogeneous mobility devices, and for example, to a system and method for managing a smart building to improve operation processing of an aerial mobility device and enables the aerial mobility device to establish smooth support and an integrated link to a ground mobility device.

### BACKGROUND

With advances in technology, various transportation mobility devices are emerging. To improve traffic congestion on the ground and urban environment deterioration, advanced aerial mobility (AAM) devices are being actively developed. An AAM device is capable of moving to a specific point in a complicated urban area and providing a service linked to another type of mobility device such as a ground mobility device.

A facility in which services can be provided between an AAM device and a ground mobility device (such a facility being referred to as a smart building or smart vertiport) is needed.

### SUMMARY

The following summary presents a simplified summary of certain features. The summary is not an extensive overview and is not intended to identify key or critical elements.

Systems, apparatuses, and methods are described for managing a smart building. A system may comprise a smart building comprising: a vertiport zone, and a complex zone configured to support operation of an aerial mobility device, that lands in the vertiport zone, and a ground mobility device; and a managing device comprising: at least one processor, and a memory storing at least one instruction that, when executed by the at least one processor, configures the at least one processor to: generate, based on management information, movement route information of the aerial mobility device in the vertiport zone, wherein the management information is associated with management of at least one of: a transport object of the aerial mobility device, or flight of the aerial mobility device; based on the movement route information indicating at least one designated area of the vertiport zone and on a charging permission condition being satisfied, set the movement route information to comprise a layover point of a charging site in the vertiport zone and control the aerial mobility device to move to the charging site according to the set movement route information and to be charged, and based on the movement route information indicating to move the aerial mobility device to the complex zone, control the aerial mobility device to move to an exit area, of the vertiport zone, approaching the complex zone.

Also, or alternatively, a method may be for managing a smart building comprising a vertiport zone, and a complex zone configured to support operation of an aerial mobility device and a ground mobility device. The method may comprise: generating, based on management information, movement route information of the aerial mobility device in the vertiport zone, wherein the management information is associated with management of at least one of: a transport object of the aerial mobility device, or flight of the aerial mobility device; based on the movement route information indicating at least one designated area of the vertiport zone and on a charging permission condition being satisfied, setting the movement route information to comprise a layover point of a charging site in the vertiport zone and controlling the aerial mobility device to move to the charging site according to the set movement route information and to be charged; and based on the movement route information indicating to move the aerial mobility device to the complex zone, controlling the aerial mobility device to move to an exit area, of the vertiport zone, approaching the complex zone.

These and other features and advantages are described in greater detail below.

### BRIEF DESCRIPTION OF THE DRAWINGS

FIG. 1 is a view exemplifying a smart building according to the present disclosure.

FIG. 2 is a view exemplifying a vertiport zone.

FIG. 3 is a view showing constituent modules of a managing device according to an example of the present disclosure.

FIG. 4 is a view showing constituent modules of a mobility device according to the present disclosure.

FIG. 5 is a flowchart showing a method for managing a smart building for integrated operation of heterogeneous mobility devices according to another example of the present disclosure.

FIG. 6 is a flowchart showing a method for managing a smart building according to still another example of the present disclosure.

FIG. 7 is a flowchart showing a method for managing a smart building according to yet another example of the present disclosure.

### DETAILED DESCRIPTION OF DISCLOSURE

Hereinafter, examples of the present disclosure are described in detail with reference to the accompanying drawings so that those having ordinary skill in the art may easily implement the present disclosure. However, examples of the present disclosure may be implemented in various different ways and thus the present disclosure is not limited to the examples described therein.

In describing examples of the present disclosure, well-known functions or constructions have not been described in detail since a detailed description thereof may have unnecessarily obscured the gist of the present disclosure. The same constituent elements in the drawings are denoted by the same reference numerals and a repeated or duplicative description of the same elements has been omitted.

In the present disclosure, if an element is simply referred to as being “connected to”, “coupled to” or “linked to” another element, this may mean that an element is “directly connected to”, “directly coupled to”, or “directly linked to” another element or this may mean that an element is connected to, coupled to, or linked to another element with another element intervening therebetween. In addition, If an element “includes” or “has” another element, this means that one element may further include another element without excluding another component unless specifically stated otherwise.

In the present disclosure, the terms first, second, etc. are only used to distinguish one element from another and do not limit the order or the degree of importance between the elements unless specifically stated otherwise. Accordingly, a first element in an example could be termed a second element in another example, and, similarly, a second element in an example could be termed a first element in another example, without departing from the scope of the present disclosure.

In the present disclosure, elements are distinguished from each other for clearly describing each feature, but this does not necessarily mean that the elements are separated. In other words, a plurality of elements may be integrated in one hardware or software unit, or one element may be distributed and formed in a plurality of hardware or software units. Therefore, even if not mentioned otherwise, such integrated or distributed examples are included in the scope of the present disclosure.

In the present disclosure, elements described in various examples do not necessarily mean essential elements, and some of them may be optional elements. Therefore, an example composed of a subset of elements described in an example is also included in the scope of the present disclosure. Examples including other elements in addition to the elements described in the various examples are also included in the scope of the present disclosure.

The advantages and features of the present disclosure and the ways of attaining them should become apparent to those of ordinary skill in the art with reference to examples of the present disclosure described below in detail in conjunction with the accompanying drawings. The examples of the present disclosure, however, may be embodied in many different forms and should not be constructed as being limited to the example examples set forth herein. Rather, the examples described herein are provided to make this disclosure more complete and to fully convey the scope of the present disclosure to those having ordinary skill in the art to which the present disclosure pertains.

In the present disclosure, each of phrases such as “A or B”, “at least one of A and B”, “at least one of A or B”, “A, B or C”, “at least one of A, B and C”, and each of the phrases such as “at least one of A, B or C” and “at least one of A, B, C or combination thereof” may include any one or all possible combinations of the items listed together in the corresponding one of the phrases.

In the present disclosure, expressions of location relations used in the present specification such as “upper”, “lower”, “left” and “right” are employed for the convenience of explanation, and If drawings illustrated in the present specification are inversed, the location relations described in the specification may be inversely understood. If a component, device, element, or the like of the present disclosure is described as having a purpose or performing an operation, function, or the like, the component, device, or element should be considered herein as being “configured to” meet that purpose or perform that operation or function.

A smart building may be configured to process various tasks, such as fusion/interfacing between heterogeneous mobility devices (e.g., between an aerial mobility and a robot operated in the building), passenger transit, transshipment, and/or a link to a means of transportation between the building and a region outside the building.

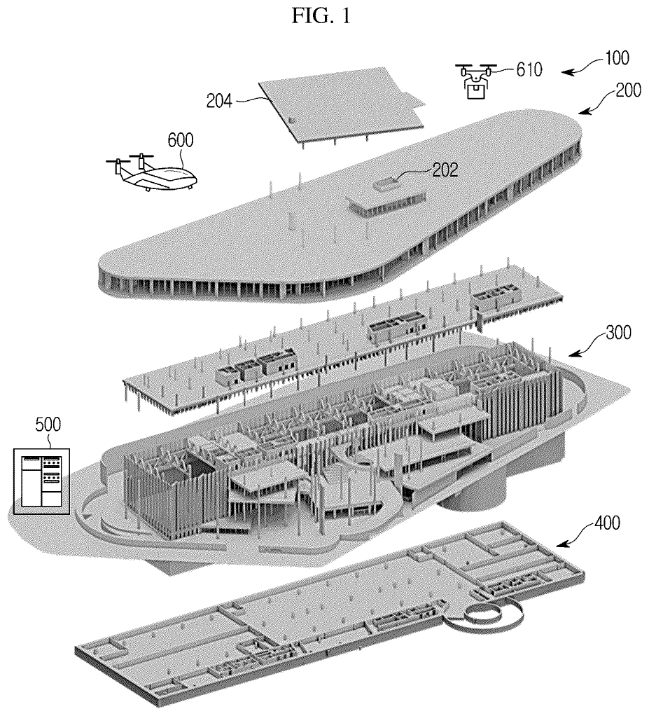

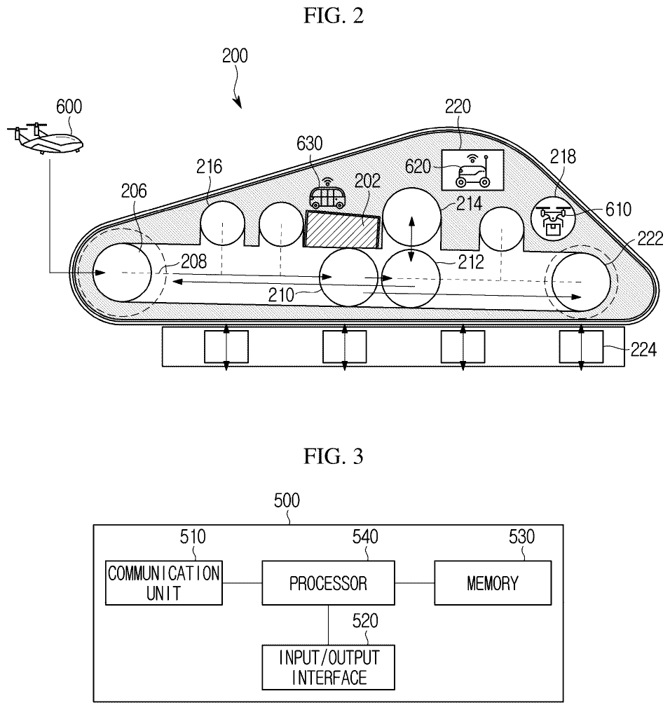

Hereinafter, referring to FIG. 1 and FIG. 2, a smart building according to the present disclosure will be described. FIG. 1 is a view exemplifying a smart building according to the present disclosure. FIG. 2 is a view exemplifying a vertiport zone.

A smart building 100 may control aerial mobility devices 600 and/or 610 to carry transport objects through takeoff and landing. The smart building 100 may control the aerial mobility devices 600 and/or 610 to provide thereto a linked service of another mobility device (not shown) that moves outside the building. Also, or alternatively, the smart building 100 may be equipped with ground mobility devices 620 and 630 that support operation of the aerial mobility device 600 processed in the building. The ground mobility devices 620 and 630 may transfer a transport object of the aerial mobility devices 600 and 610 within the building or support energy supply and maintenance for the aerial mobility devices 600 and 610, while traveling a plurality of zones and areas of the smart building 100. Another mobility device, which carries a transport object to a building or the outside thereof, may include, for example, a conventional vehicle, a route vehicle, a shared vehicle, a small personal mobility (e.g., electronic scooter, bicycle), and public transportation. Also, or alternatively, apart from a mobility service, the smart building 100 may have amenities for people who use the building.

For example, a transport object may be passengers and cargo. For example, the aerial mobility devices 600 and 610 may be, either or respectively, an AAM device capable of carrying a passenger and cargo and providing a personalized aerial service within a predetermined region, a small unmanned aerial vehicle (UAV or drone), which usually carries cargo or carries out a predetermined task such as photography and fluid jetting, a helicopter, and the like. For example, the ground mobility devices 620 and 630, which move inside the building 100, may include a robot and a purpose-based carrier (e.g., that may be implemented by autonomous driving/control).

Specifically, the smart building 100 may include a vertiport zone 200, a complex zone 300, and a supplementary zone 400. In FIG. 1, the zones 200, 300 and 400 are exemplified in vertical arrangement but are not limited thereto and may be placed in various modes as long as the zones are separated from each other with respect to functions. Each of the zones may have a facility capable of moving between them, and the ground mobility devices 620 and 630 may move across the zones. The vertiport zone 200 may provide a take-off/landing space of the aerial mobility devices 600 and 610, a waiting space of the devices, and a simple service of the devices and also have a board/alight space for a transport object. The complex zone 300 may be a zone where the aerial mobility devices 600 and 610, which are going to take off in a predetermined time or require a specific work, are transported from the vertiport zone 200 and are kept. The supplementary zone 400 may be a zone which transport objects access to be carried by the aerial mobility devices 600 and 610. For example, the supplementary zone 400 may have a space for holding another mobility device that provides a linked service of the aerial mobility devices 600 and 610 to enable the devices to be used.

Specifically, the vertiport zone 200 may include a passenger terminal 202 with a roof 204 installed thereon, a first take-off/landing area 206, a taxiway 208, an object board/alight area 210, a rotator 212, a charging site 214, a waiting area 216, a second take-off/landing area 218, a storage area 220, and a shift area 222.

The passenger terminal 202 is an area for waiting to load passengers and cargo or unload them, and the cargo may be held or arranged by being distinguished according to the aerial mobility devices 600 and 610 where the cargo is loaded or unloaded. The roof 204 may be installed to prevent a transport object from being damaged in bad weather.

The first take-off/landing area 206 and/or the second take-off/landing area 218 may each be a site where the aerial mobility devices 600 and/or 610 take off and/or land. The first take-off/landing area 206 and/or the second take-off/landing area 218 may be provided only to the aerial mobility devices 600 and/or 610 with a specific type. For example, the aerial mobility device 600 may be an AAM device, which may use the first take-off/landing area 206. The aerial mobility device 610 may be a UAV, which may be smaller than the AAM device, and may use the second take-off/landing area 218. In FIG. 1, the first take-off/landing area 206 and the second take-off/landing area 218 are each exemplified in a number of one but may be provided in a plural number. FIG. 1 exemplifies a take-off/landing area for both take-off and landing, but another example may separate a take-off area and a landing area. The AAM device may be equipped with wheels and thus move to a zone or area of the smart building 100 on its own. The UAV may not be equipped with any wheel and thus be moved manually by a cart that transports a device. Even if the AAM device is equipped with wheels, a cart may load and transport the AAM device.

The first take-off/landing area 206 and/or the second take-off/landing area 218 may be equipped with three separate sections. For example, the first take-off/landing area 206 and the second take-off/landing area 218 may include a touchdown and liftoff (TLOF) section, a final approach and takeoff (FATO) section, and a safety section. The TLOF may be a generally-paved area that supports take-off/landing loads of the aerial mobility devices 600 and/or 610. The FATO may be an area in a space where the aerial mobility devices 600 and/or 610 complete a final approaching step for hovering or landing, or an area in a space where the aerial mobility devices 600 and/or 610 start an initial step of taking off from a hovering or landing position. The TLOF may be at the center of the FATO. The safety area may be an area in a space that surrounds the FATO to provide an additional buffer zone.

The first take-off/landing area 206 and/or the second take-off/landing area 218 may be equipped with various sensing modules (e.g., sensors, such as weight sensors, timing sensors, motion detectors/sensors, distance sensors, thermometers, light sensors, etc.) and a module (e.g., transceiver, receiver/transmitter) for supporting communication between the aerial mobility devices 600 and/or 610 and the managing device 500 (e.g., throughout the smart building 200). For example, a sensing module may be equipped with one or more of a camera, a 3D space detection sensor, a distance measuring sensor for measuring a space between the plurality of aerial mobility device 600, a distance between the aerial mobility device 600 and a take-off/landing area, and the like.

The taxiway 208 may be a route (or runway) configured for the aerial mobility device 600 to move to a designated area of the vertiport zone 200. The taxiway 208 may be a mark constructed, for example, as a combination of a line and a color on a floor surface. The designated area may be a specific point of the vertiport zone 200 that is determined based on management information of the aerial mobility devices 600 and 610 and where the managing device 500 lands. The designated area may include at least one of the first take-off/landing area 206, the object board/alight area 210, the charging site 214, the waiting area 216, and the second take-off/landing area 218.

The object board/alight area 210 is a loading/unloading site of a transport object for the aerial mobility devices 600 and 610 and may be a space for a passenger's boarding and alighting and cargo handling. The object board/alight area 210 may be a site where both a passenger and cargo board and alight in a same space, or consist of two sites that are separated for a passenger and cargo respectively.

The charging site 214 may be equipped with at least one charger, which charges the aerial mobility devices 600 and 610, and a module that transmits a charge progress state of a device to the managing device 500 and controls charging (e.g., based on information/signals from the management device 500). The charging site may comprise a charger. As another example, the charging site may comprise various types of energy feeders according to an energy source of the aerial mobility devices 600 and 610, for example, a feeder that supplies fossil energy-based liquid and/or gas.

The rotator 212 may be placed in front of the charging site 214 on a movement route to the charging site 214. If the aerial mobility device 600 enters the rotator 212, the rotator 212 may rotate the aerial mobility device 600 to make a predetermined portion of the aerial mobility device 600 such as a head directed to the charging site under the control of the managing device 500.

The waiting area 216 may be a site where the aerial mobility device 600, which is going to take off in a predetermined time, waits to be moved to the object board/alight area 210. The storage area 220 may be a zone where the ground mobility devices 620 and 630 stop and wait for a request of the managing device 500 in the vertiport zone 200. For example, the ground mobility devices 620 and 630 may be the robot and the purpose-based carrier, and the storage area 220 may not be provided as a site where the aerial mobility device 600 stops or waits. The shift area 222 may be an area in which the aerial mobility device 600 stops over while moving in the complex zone 300 or an area in which the aerial mobility device 600 transferred from the complex zone 300 to the vertiport zone 200 stops over while moving to a designated area.

The aerial mobility device 600, which is transferred to the shift area 222, may be equipped with at least one elevator 224 in order to move to the complex zone 300. Also, or alternatively, If the aerial mobility device 600 has loaded cargo in the complex zone 300 and is going to take off with passengers aboard, the elevator 224 may load the aerial mobility device 600, which is going to take off, and transfer the aerial mobility device 600 to the vertiport zone 200 under the control of the managing device 500. The elevator 224 may be equipped with a weight measuring module (e.g., weight measurement device comprising a weight measurement sensor, such as a scale) that provides a weight of cargo loaded in the aerial mobility device 600, which is going to take off, and a weight distribution.

The complex zone 300 may be used to perform a specific task for the aerial mobility device 600 at a request or control of the managing device 500. For example, the specific task may be cargo handling, maintenance of the aerial mobility device 600, charging, and passenger boarding. The complex zone 300 may be equipped with various equipment (e.g., device(s)) for processing a specific task. For example, the equipment may include the robot 620 for handling, maintenance and charging, the carrier 630 for supporting handling and passenger boarding, and service equipment for precise repair. The complex zone 300 may have various modules installed for identifying, transmitting/sending and/or receiving a request and/or information about a situation associated with a specific task between the aerial mobility device 600 and the managing device 500.

Hereinafter, referring to FIG. 3, a managing device and a mobility device operated in a smart building will be described according to an example of the present disclosure. FIG. 3 is a view showing constituent modules of a managing device according to an example of the present disclosure.

The managing device 500 may exchange data with modules (e.g., receivers/transmitters/transceivers) installed in every zone of the smart building 100, the mobility devices 600 to 630 present in the building, another mobility device linked to the outside thereof, and an external mobility service server, thereby controlling overall operation of the mobility devices inside the building and managing a mobility service provided in the building. Also, or alternatively, the managing device 500 may provide information associated with a mobility service provided in the smart building 100 to a user terminal held by a visitor using the smart building 100 and a user of a mobility device. Furthermore, the managing device 500 may manage various convenience facilities, which stay in the smart building 100 to provide a visitor's convenience, and exchange data with a computing device installed in a convenience facility. As exemplified in FIG. 1, the managing device 500 may be installed inside the smart building 100, or as another example, may be constructed outside the smart building 100 for remote management.

The managing device 500 may include a communication unit 510, an input/out interface 520, a memory 530, and a processor 540.

The communication unit 510 may communicate with the aerial mobility device 600 using the smart building 100, the ground mobility devices 620 and 630 supporting the aerial mobility device 600, another mobility device that is externally linked, sensing modules (e.g., sensors) and control modules (e.g., controllers) constructed in each of the zones 200, 300 and 400 for controlling the operation and state of a mobility device, and/or a computing module of a convenience facility. The communication unit 510 may receive management information from the aerial mobility device 600, which is going to land or take off, or an external server controlling the aerial mobility device 600 and transmit an instruction of the device that is generated based on the management information. Also, or alternatively, the communication unit 510 may transmit support-related instruction information, which is generated based on the management information, to the ground mobility devices 620 and 630 and receive data associated with a support state and control from the ground mobility devices 620 and 630.

The input/output interface 520 may be equipped with an input device for receiving a request of a manager of the smart building 100, an output device for providing state and/or control results of a mobility device using the smart building 100, and/or an adapter interface for connection with another device.

The memory 530 may store an application and/or a variety of data for integrated operation of the aerial mobility device 600 using the smart building 100, the ground mobility devices 620 and 630 and another mobility device. The processor 540 may load the application from the memory 530, and read data from and/or record data to the memory 530. Also, or alternatively, the memory 530 may possess internal data used for managing various facilities of the smart building 100 and external data that is transmitted to the building 100.

The processor 540 may perform overall control for a mobility device using the smart building 100 and the managing device 100 that operates each of the zones 200 to 400 and facilities. The processor 540 may be configured to execute an application and an instruction stored in the memory 530. The processor 540 may receive various data from a mobility device using the smart building 100 or supporting a service of the building, each of the zones 200 to 400, and a convenience facility, create and transmit supervision information, and control the above-listed devices and a target facility by using the information. The supervision information may include data for processing a cooperative operation between a mobility device and each zone.

The processor 540 may establish (e.g., generate, determine) movement route information of the aerial mobility device 600 in the vertiport zone 200 based on management information associated with managing at least one of a transport object and flight of the aerial mobility device 600 landing on the vertiport zone 200 by using an application, an instruction, and data stored in the memory 530.

The management information may include state information, operation information, and flight approval information. As described below, the state information, the operation information, and the flight approval information may each include multiple pieces of detailed information of the management information.

The state information may include states associated with the operation, control, component and energy refilling of the aerial mobility device 600. In case the aerial mobility 600 is driven based on an electrical battery, the state information may include, for example, state-of-charge information and aerial vehicle state information. For example, the aerial vehicle state information may include an operation state of a hardware component like a part and an operation state of a software component for flight control. Also, or alternatively, the aerial vehicle state information may include a maintenance request of an abnormal component at an automatic inspection of the aerial mobility device 600 or a pilot's request and an overall weight including the vehicle body, occupants and cargo. In case the aerial mobility device 600 is driven based on a fuel cell or fossil energy, the state information may further include information associated with fuel and a refueling state.

The operation information may include information associated with managing the flight and transport objects in the aerial mobility device 600. The flight information may include route information including a depart point, a layover point and a destination, a waiting time at the vertiport zone 200 of the aerial mobility device 600, and take-off and landing times according to a route of the aerial mobility device 600. In relation to a transport object, the operation information may include boarding information, cargo information, handling information, and passenger boarding state information. The boarding information may include a current situation of passengers who board or alight from the aerial mobility device 600. For example, the cargo information may include the weight, size and unloading region of cargo that is loaded in the aerial mobility device 600. For example, the handling information may be information associated with an individual piece of cargo, which is loaded or unloaded, and a handling region of the cargo. For example, the passenger boarding state information may include an overall weight of passengers boarding the aerial mobility device 600 and in-cabin placement information of the passengers.

The flight approval information may include permission associated with take-off/landing and flight of the aerial mobility device 600 managed in the vertiport zone 200, passenger boarding permission, and cargo loading permission.

If movement route information is established to move to at least one designated area of the vertiport zone and satisfies a charging permission condition, the processor 540 may set the movement route information to stop at the charging site 214 of the vertiport zone 200. The processor 540 may control the aerial mobility device 600 to move to the charging site 214 according to the set movement route information and to be charged there. The charging permission condition may be a case where an energy state of the landing aerial mobility device 600 is equal to or less than a threshold value, and the threshold value may be randomly designated or be an energy state that enable flight to a next arrival to be possible.

Also, or alternatively, the movement route information is established to move the aerial mobility device 600 from the vertiport zone 200 to the complex zone 300 without layover at a designated area associated with take-off/landing, loading/unloading of a transport object, waiting and maintenance, the processor 540 may control the aerial mobility device 600 to move to an exit area of the vertiport zone 200 that approaches the complex zone 300.

Also, or alternatively, in order to process cargo handling and maintenance in a predetermined zone, based on management information, the processor 540 may control the aerial mobility device 600, the ground mobility devices 620 and 630, and a module for states and controls associated with handling and maintenance. The processor 540 may identify a weight distribution of passengers and/or cargo, provide an optimized position to the aerial mobility device 600 to optimize a location of a transport object inside the aerial mobility device 600 and/or control movement of cargo by the ground mobility devices 620 and/or 630.

The processor 540 may be implemented as a single processing module (e.g., a processor) and/or as distributed processing by a plurality of processing modules (e.g., processors). The processor 540 in the present disclosure may collectively refer to the plurality of processing modules.

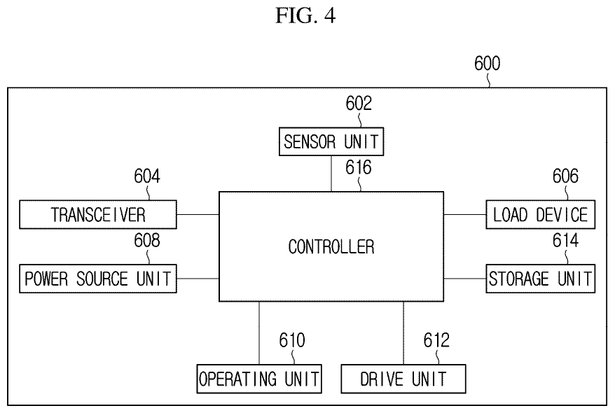

FIG. 4 is a view showing constituent modules of a mobility device according to the present disclosure. As described above, a mobility device using the smart building 100 and/or staying in the smart building 100 may include the aerial mobility devices 600 and the ground mobility devices 620 and/or 630. The aerial mobility devices 600 and/or 610 may be an AAM device and the unmanned aerial vehicle (e.g., a drone). The ground mobility devices 620 and 630 may include the robot 620 and the purpose-based carrier 630. In FIG. 4, the aerial mobility device 600 is discussed for clarity of explanation, but FIG. 4 describes a module commonly applicable to any of aerial or ground mobility devices 600, 610, 620, or 640.

The mobility device 600 may be moved by manual operation, autonomic control, or a combination thereof. Manual operation may be implemented by a driver or an operator through an interface such as a control device provided in the mobility device 600 or may be implemented by remote control from a control center or an outside control station. Autonomic control, that is, autonomous movement, may be performed by independent processing of the mobility device 600 or may be performed by a combination of remote control through a control center and cooperative processing between the mobility device 600 and the control center.

The mobility device 600, which is operated in various forms, may be designed differently according to a uses, a movement space, a driving method, and a control method, but have common functional modules exemplified in FIG. 4 from a comprehensive perspective like mobility. FIG. 4 depicts main common functions in various types of the mobility devices 600. Accordingly, although an intrinsic functional module used in each type is omitted, an example of the present disclosure does not exclude any module omitted by the mobility device 600 in FIG. 4, and such a module is not excluded from the scope of right according to this example.

The mobility device 600 may include a sensor unit 602, a transceiver 604, and a load device 606.

The sensor unit 602 may be equipped with various types of detectors for sensing various states and situations occurring in external and internal environments of the mobility device 600 and for identifying location information of the mobility device 600. That is, the sensor unit 602 may include heterogeneous sensors and obtain sensing data detected from each sensor. The sensor unit 602 may obtain sensor data used for movement control, state data for detecting a state of a module of the mobility device 600, and situation data for sensing/determining/characterizing a situation of a passenger and/or a load and provide these data to a controller 616 causing a predetermined function and an operation. In the present disclosure, the movement control may be at least one of a linear movement, a turn, and acceleration/deceleration of the mobility device 600, attitude control of the mobility device 600, and an operation associated with braking and hovering. The above-described data of the sensor unit 602 is illustrative and further include sensor data for sensing various situations not listed herein.

The transceiver 604 may support mutual communication with another device outside to exchange data with the other device. For example, the other device may be the managing device 500, which controls the mobility device or mutually exchanges data associated with movement control of the mobility device, an additional device for supporting movement, another mobility device, and the like. A protocol applied to the transceiver 604 is determined according to a type of the mobility device 600, and for example, the mobility device 600 may communicate with another vehicle or another device based on cellular communication, wireless access in vehicular environment (WAVE) communication, dedicated short range communication (DSRC) or short range communication, or any other communication scheme. The above-listed communication protocols and schemes are illustrative, and the present disclosure is not limited thereto.

The load device 606 may be an auxiliary equipment mounted on the mobility device 600, which consumes electric power supplied from a power source unit 608 by an instruction required for the user of a user or the management of a load or converted from output of the power source unit 608. The load device 606 may be a type of electric device for non-mobility purpose excluding a mobility power system used in a drive unit 612 in the present disclosure. For example, the load device 606 may be various devices installed in a display system, an air-conditioning system, a light system, a seat system, and the mobility device 600.

Although not illustrated in FIG. 4, the mobility device 600 may include an interface for movement control and for receiving a request for an operation of the load device 606. The interface may be implemented as a hardware device or a software interface. For example, the software interface may be a display with touch input function but is not limited thereto.

Also, or alternatively, the mobility device 600 may include the power source unit 608, an operating unit 610, and the drive unit 612.

The power source unit 608 may generate and supply power and electricity used for a mobility power system like the drive unit 612 and the load device 606. The mobility device 600 may generate energy by at least one of various energy sources. In case the mobility device 600 is driven based on electric energy, for example, the power source unit 608 may be configured as an electric battery or be configured as a combination of an electric battery and a charging module for charging the battery. In case the power source unit 608 is configured as an electric battery alone, the electric battery may be charged from a charging station or another mobility device and supply electricity. In case the power source unit 608 is a combination of an electric battery and a charging module, the power source unit 608 may employ at least one of a fuel cell and a fossil energy-based engine for the charging module. A fuel cell may use a material used for electric power production, for example, hydrogen gas. In case the charging module is an engine, the power source unit 608 may be equipped with a generator coupled with the engine, and the generator may convert mechanical energy generated from the engine to electric energy and charge an electric battery with the converted electric energy.

As another example, in case the mobility device 600 is driven based on fossil energy, the power source unit 608 may be configured as an internal combustion engine or a turbine engine. As yet another example, the mobility device 600 may have the power source unit 608 which is configured as a hybrid type of a fossil energy-based engine and an electric battery.

The operating unit 610 and the drive unit 612 may constitute an actuating unit which transfers power generated from the power source unit 608 and externally implements a predetermined moving motion. In the present disclosure, the actuating unit is referred to as an actuator, and these terms may be used interchangeably.

The operating unit 610 may be equipped with at least one module for implementing a moving operation. In case the mobility device 600 is an aerial mobility device, the operating unit 610 may be equipped with mechanical and software components which perform at least one operation of control of aircraft attitudes such as roll, yaw and/or pitch of the aerial mobility device 30, hovering control associated with take-off and landing, and flap control for a change of altitude and a turning operation. In case the mobility device 600 is a ground mobility, the operating unit 610 may have mechanical and software components which implement at least one driving operation of longitudinal control such as acceleration and deceleration and transverse control such as steering. The operating unit 610 of the ground mobility may further include a module for transferring power from the power source unit 608 to the drive unit 612 and/or a module for converting power to the drive unit 612 into a predetermined size and a predetermined form.

The drive unit 612 is a module for externally implementing a linear movement, a turn, and acceleration/deceleration of the mobility device 600, attitude control of the mobility device 600, and operations of braking and hovering and may be implemented in various forms according to a type of the mobility device 600. In the case of the aerial mobility device 600 (e.g., the AAM device), the drive unit 612 may be a rotor-type propeller, flap, and the like, which is installed in at least one of a main wing, a tail wing, and the body. According to specifications of the AAM device 600, the drive unit 612 may be equipped with a wheel such as a landing gear which is held within a body during flight and is drawn out during take-off and landing. In the case of the small UAV, the drive unit 612 may be composed of a plurality of propellers installed on a frame on an upper body part. In case the mobility devices are the ground mobility devices 620 and 630, the drive unit 612 may include a plurality of wheels, a driving force transfer module (e.g., engine, motor) for generating and giving a driving force to wheels or for transferring a driving force, a braking module (e.g., brakes) for decelerating the driving of wheels, and a steering module (e.g., steering) for realizing transverse control of wheels. A wheel, a driving force transfer module, and a braking module may constitute a drive assembly, and a plurality of drive assemblies may be provided according to a number of wheels.

Also, or alternatively, the aerial mobility device 600 may include a storage unit 614 and a controller 616.

The storage unit 614 may store an application for controlling the mobility device 600 and various data and load the application or read and record data at a request of the controller 616. An application and data may be different according to a type and detailed specifications of the mobility device 600 and include sensor data associated with movement control, state data of the mobility associated with movement control, data received from another device, and data associated with energy control between the power source unit 608 and the drive unit 612. Also, or alternatively to this, the application and the data may include data associated with control of a module in charge of functions other than the above-described controls, software associated with operation of a computing system of the mobility, information and an application for autonomous movement, route information, various information for boarding convenience, and a control program.

In the present disclosure, the controller 616 may process movement control, route control, energy control, control of the load device 606, autonomous movement control, and convenience function control by using an application, an instruction, and data which are stored in the storage unit 614. The controller 616 may also have different control processes according to a type and detailed specifications of the mobility device 600.

As an example, the controller 616 may be implemented as a single processing module. As another example, processing according to the above description may be performed as distributed processing in a plurality of processing modules, and the controller 616 in the present disclosure may collectively refer to the plurality of processing modules.

Hereinafter, integrated operation by the managing device 500 for the aerial and ground mobility devices 600, 610, 620 and 630 using or staying in the smart building 100 and each of the zones 200 to 400 will be described in detail through FIG. 1 to FIG. 7.

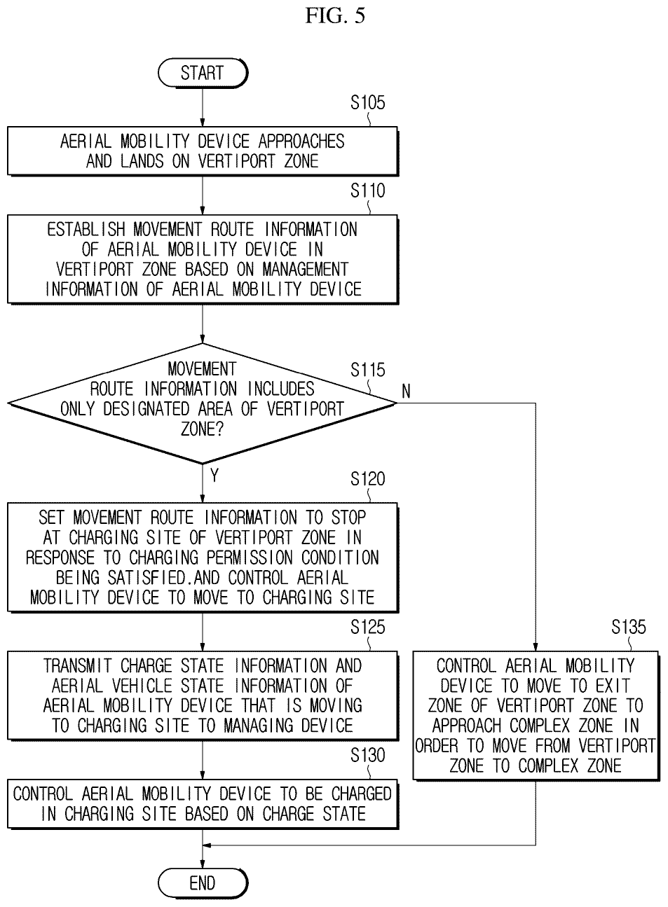

FIG. 5 is a flowchart showing a method for managing a smart building for integrated operation of heterogeneous mobility devices according to another example of the present disclosure. A process according to FIG. 5 to FIG. 7 is performed by the processor 540 of the managing device 500, but hereinafter, for convenience of explanation, the managing device 500 and the processor 540 may be described interchangeably. Furthermore, in the description below, the aerial mobility device 600 may be described mainly as the AAM device. However, an aerial mobility device may also, or alternatively, include the UAV (e.g., a drone), and the description below may be applicable to the aerial mobility device 610.

The managing device 500 may perceive the aerial mobility device 600 approaching the vertiport zone 200 and approve of the aerial mobility device 600 landing, and the aerial mobility device 600 may be controlled by the managing device 500 to land on the take-off/landing areas 206 and 218 (S105).

The managing device 500 may establish movement route information of the aerial mobility device 600 in the vertiport zone 200, based on management information associated with at least one of a transport object and flight of the aerial mobility device 600 that is landing (S110).

As an example, the management information may be transmitted to the managing device 500 via communication with the aerial mobility device 600. As another example, the management information may be transmitted from an external server controlling the aerial mobility device 600 to the managing device 500. Also, or alternatively, a part of detailed information constituting the management information may be created by the managing device 500. For example, handling information and passenger state information, which are collected in the managing device 500 in real time, may be produced by the managing device 500 and be incorporated into the management information.

For example, in case flight information of the management information is scheduled to load a transport object within a predetermined time and fly to a next destination, movement route information may be created as a route including, as designated areas, the take-off/landing areas 206 and 218, the object board/alight area 210, and the waiting area 216. In case handling information of the management information is indicated to unload loaded cargo in a designated cargo handling area of the object board/alight area 210 or the vertiport zone 200, the movement route information may be created as a route including, as designated areas, the take-off/landing areas 206 and 218, the object board/alight area 210 or a cargo handling area and the take-off/landing areas 206 and 218. In case aerial vehicle state information of the management information is indicated to request inspection and repair for a specific component, the movement route information may be created as a route including, as designated areas, the take-off/landing areas 206 and 218, the charging site 214 or a designated service area, the waiting area 216 and the take-off/landing areas 206 and 218. In case flight information is indicated to take off in a predetermined time or aerial vehicle state information is indicated to require precise inspection and in-depth service, the movement route information may be created as a route where the aerial mobility device 600 is moved to an exit area of the vertiport zone 200 approaching the complex zone 300 without layover in any other area of the vertiport zone 200. For example, the exit area may be the shift area 222 which is a stopping area before moving to an elevator 224.

If the movement route information is established to move only to at least one designated area of the vertiport zone 200 (Y of S115), the managing device 500 may set the movement route information to stop at the charging site 214 of the vertiport zone 200, in response to a charging permission condition being satisfied. Also, or alternatively, the managing device 500 may control the aerial mobility device 600 to move to the charging site 214 according to the set movement route information (S120).

The managing device 500 may check whether or not the movement route information consists of a designated area of the vertiport zone 200 without the complex zone 300. The designated area may be an area in the vertiport zone 200 exemplified at step S110. After the checking, in case the movement route information consists only of the designated area of the vertiport zone 200, the managing device 500 may check a charge state of the aerial mobility device 600 based on charge state information and identify whether or not the charge state is equal to or less than a threshold value according to the charging permission condition. For example, the charging permission condition may be randomly designated or be a charged amount required for flight to a next destination. In case the charge state is equal to or less than the threshold value, the charging permission condition is satisfied, and the managing device 500 may modify the pre-established movement route information to stop at the charging site 214. The movement route information may be modified to arrange a designated area and the charging site in sequence or may be modified in consideration of movement routes of another area mobility 600 and the ground mobility devices 620 and 630.

If the aerial mobility device 600 moves to a designated area and the charging site 214 according to the movement route information, the aerial mobility device 600 may move along the taxiway 208 that guides to the area and the charging site 214. By switching control right to the managing device 500, the aerial mobility device 600 may be moved by being controlled by the managing device 500. As another example, the aerial mobility device 600 may be moved by the robot 620 or a cart provided in the vertiport zone 200. As still another example, as the managing device 500 may transmit the movement route information to the aerial mobility device 600, the aerial mobility device 600 may be moved by a pilot's taxing manipulation so that movement of the aerial mobility device 600 may be controlled by the managing device.

As shown in FIG. 2, in case the managing device 500 perceives the aerial mobility device 600 entering the rotator 212 located on a route to the charging site 214, the managing device 500 may control the rotator 212 to rotate the aerial mobility device 600 so that a predetermined portion such as a head part of the aerial mobility device 600 heads to the charging site 214. Collision with another mobility device may be prevented which could occur If the aerial mobility device 600 turns in the narrow vertiport zone 200 and then moves to the charging site 214.

The managing device 500 may receive charge state information and aerial vehicle state information from the aerial mobility device 600 that is moving to the charging site 214 (S125).

For example, the charge state information may be a remaining battery level, and the aerial vehicle state information may include an operating state of hardware and software components of the aerial mobility device 600 and a maintenance request of an abnormal component. Maintenance by the robot 620 in the charging site 214 may be simple inspection and simple service, and in case a maintenance request is simple inspection and simple service, the managing device 500 may request the robot 620, which stands by in the storage area 220 or has completed a task, to move to the charging site 214. In case a maintenance request is precise inspection and in-depth maintenance, the managing device 500 may modify the movement route information again so that the movement route information with layover in the charging site 214 includes the complex zone. The movement route information thus modified again may maintain or exclude the charging site. In case the charging site is maintained, the aerial mobility device 600 may be moved to the complex zone 300 after completion of charging (e.g., based on information indicating the aerial mobility device 600 is charged to a sufficient/threshold level, and the maintenance may be performed in the complex zone 300. In case the charging site 214 is excluded from the movement route information, the managing device 500 may control the mobility device and each of the zones 200 and 300 in order to process the charging and maintenance of the aerial mobility device 600 in the complex zone 300.

As described above, step S125 may be implemented while the aerial mobility device 600 moves to the charging site 214, but as another example, if the movement route information is completely modified which corresponds to a process implemented before movement of the device, the managing device 500 may receive charge state information and aerial vehicle state information.

The managing device 500 may control the aerial mobility device 600 to be charged in the charging site 214 based on a charge state (S130).

The charging site 214 may be equipped with a fixed charger, or the robot 620 supporting charging may approach the charging site 214. The aerial mobility device 600 may be charged by a charger or the robot 620.

Also, or alternatively, in case the aerial vehicle state information requests maintenance indicating simple inspection and simple service, the managing device 500 may request the robot 620 supporting maintenance and control maintenance of the aerial mobility device 600. In this case, the robot 620 and the aerial mobility device 600 may transmit a current state of inspection/service and a result to the managing device 500, and the managing device 500 may determine whether or not the aerial mobility device 600 is normally operated.

If the movement route information is established to move from the vertiport zone 200 to the complex zone 300 (N of S115), the managing device 500 may control the aerial mobility device 600 to move to an exit zone of the vertiport zone 200 to approach the complex zone 300, for example, the shift area 222 (S135).

The aerial mobility device 600 is moved along the taxiway 208 heading to the shift area 222, and detailed movement control is actually the same as at step S120. Movement from the shift area 222 to the complex zone 300 may be performed by the elevator 224, and an operation of the elevator 224 and movement of the aerial mobility device 600 in the complex zone 300 may be controlled by the managing device 500.

Even if movement route information is established as a route to the complex zone, If a charging permission condition is satisfied, the managing device 500 may modify the movement route information to include layover at the charging site 214. The charging permission condition may be the same as described at step S120. As another example, apart from step S120, the charging permission condition may be determined in consideration of flight information of the aerial mobility device 600 and a charging support state of the complex zone 300. For example, if it is not possible to charge the aerial mobility device 600 for one hour in the complex zone 300 (e.g., if the aerial mobility device 600 is going to take off in one hour), the managing device 500 may determine that the charging permission condition in the charging site 214 is satisfied.

In case movement route information includes the charging site 214 and the complex zone 300, the managing device 500 may control the aerial mobility device 600 to move to and be charged in the charging site 214, which is similar to steps S120 to S130.

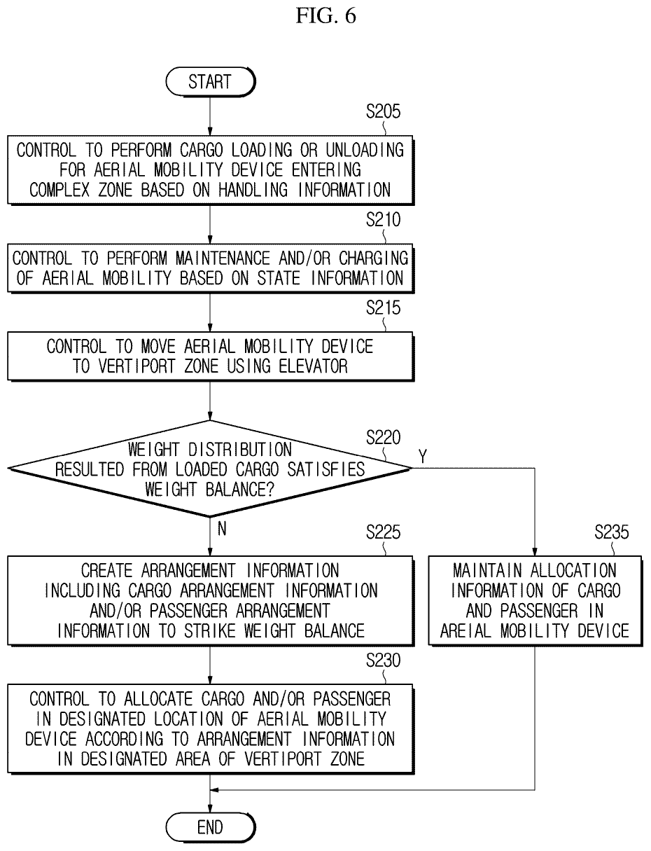

FIG. 6 is a flowchart showing a method for managing a smart building according to still another example of the present disclosure. FIG. 6 is an example that is related to handling and maintenance of the aerial mobility device 600 in the complex zone 300 and an arrangement setting of a transport object for safe flight.

The managing device 500 may perceive the aerial mobility device 600 entering the complex zone 300 by the elevator 224, check handling information of management information, and control the aerial mobility device 600, the robot 620 of the complex zone 300, and a relevant module to load or unload cargo based on the handling information (S205).

The aerial mobility device 600 may be moved to a preset area of the complex zone 300, and the movement may be performed similar to what is described at step S120. The managing device 500 may check handling information associated with cargo to be loaded in or unloaded from the aerial mobility device 600 and also check a weight resulting from cargo to be loaded, an unloading region of a planned flight route, and a passenger boarding state of planned flight. Based on the above-described information and state, the managing device 500 may create cargo arrangement information with a loaded form of cargo inside the aerial mobility device 600. The managing device 500 may control the robot 620 provided in the complex zone 300 and load cargo in a designated location in the aerial mobility device 600 according to cargo arrangement information. As another example, the managing device 500 may control the robot 620, which is parked in the storage area 220 of the vertiport zone 200 or has completed a task, to move to the complex zone 300 and transmit detailed information such as instruction information according to the above-described state and information to the robot 620. The managing device 500 may control the robot 620 to perform processing according to instruction information, for example, unloading cargo according to handling information in the aerial mobility device 600. As another example, cargo arrangement information may be transmitted to a device (e.g., carrier and/or robot) of a manager that loads baggage so that the manager may load cargo in a designated location, and thus the managing device 500 may control cargo loading.

During a handling task or after completion thereof, the managing device 500 may control the aerial mobility device 600, the robot 620 of the complex zone 300, a charger and a relevant module to perform at least one of maintenance and charging of the aerial mobility device 600 based on state information including charge state information and aerial vehicle state information (S210).

For example, maintenance may be precise inspection and in-depth service, and as an example, for overall maintenance, simple inspection and simple service may be additionally included. For example, in case movement is performed to the complex zone 300 without charging in the charging site 214, charging in the complex zone 300 may be performed based on a charged amount that is determined according to flight information and cargo information. At least one of maintenance and charging may be performed in an area, where a handling task is processed, or another area. In case neither charging nor maintenance is required based on charge state information and aerial vehicle state information, step S210 may be omitted.

The managing device 500 may control the aerial mobility device 600 and the elevator 224 to move the aerial mobility device 600 to the vertiport zone 200 by using the elevator 224 (S215).

The managing device 500 may measure a weight resulted from loaded cargo and a weight distribution by using a weight measuring module (e.g., weight measurement device comprising a weight measurement sensor, such as a scale) mounted in the elevator 224 and determine whether the weight distribution satisfies a weight balance (S220).

A weight distribution may be generated to reflect an impact from a plurality of unloading regions according to a flight route and a passenger boarding state associated with an arrangement of seated passengers in the aerial mobility device 600 that is going to take off. Specifically, even If cargo is loaded in a designated location of the aerial mobility device 600 according to cargo arrangement information at step S205, if the aerial mobility device 600 is moved to the vertiport zone 200 after a long time, a final boarding passenger, final loaded cargo, and an ultimately determined layover point may be modified. Accordingly, the managing device 500 may reflect an impact of an unloading region and an arrangement of seated passengers according to modifications in a weight distribution, If the aerial mobility device 600, which is about to take off, is moved by the elevator 224. As another example, in case no cargo arrangement information is created at step S205 and cargo is randomly loaded in the aerial mobility device 600, an unloading region and an arrangement of seated passengers of the aerial mobility device 600, which is about to take off, are considered through step S220, and thus a weight balance may be identified.

For example, a weight balance may be a state of satisfying a reference safety degree required for the body and cabin of the aerial mobility device 600 in consideration of a flying body shape, a body center according to a weight distribution of transport objects, flight control required according to an aerial vehicle state and a surrounding environment, and flight safety.

If a weight distribution does not satisfy a weight balance, the managing device 500 may create arrangement information including at least one of cargo arrangement information and passenger arrangement information in order to strike the weight balance (S225).

In a designated area of the vertiport zone 200, the managing device 500 may control to place at least one of cargo and a passenger in a designated location in the aerial mobility device 600 based on the arrangement information (S230).

The designated area is an area of the vertiport zone 200, which is set according to movement route information, and may be at least one of, for example, the object board/alight area 210, the waiting area 216, and a cargo loading area.

The managing device 500 may control the robot 620 provided in the vertiport zone 200 and load cargo in a modified location in the aerial mobility device 600 according to cargo arrangement information. The robot 620 may be a robot that is parked in the storage area 220 or has completed a task. As another example, cargo arrangement information may be transmitted to a device of a manager that loads baggage so that the manager may load cargo in a modified location, and thus the managing device 500 may control cargo loading.

As the managing device 500 provides passenger arrangement information to a passenger or a manager (e.g., via a device), the managing device 500 may control a seated arrangement of passengers.

If a weight distribution satisfies a weight balance, the managing device 500 may not modify (e.g., may maintain) arrangement information of cargo and/or passengers of the aerial mobility device 600 moved to the vertiport zone 200 (S235). The passengers may be seated in locations that are previously noticed/detected, no change of location may occur to cargo.

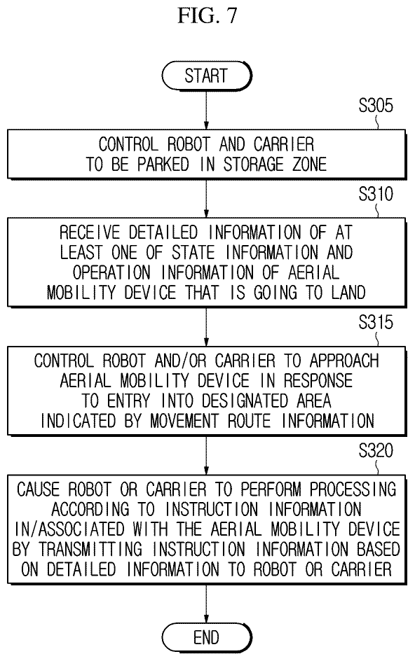

FIG. 7 is a flowchart showing a method for managing a smart building according to yet another example of the present disclosure. FIG. 7 is an example associated with an operation of a ground mobility device that supports a task for the aerial mobility device 600 in the vertiport zone 200.

The managing device 500 may control ground mobility devices supporting a task of the aerial mobility device 600. For example, the managing device 500 may control the robot 620 and/or the carrier 630 to be parked in the storage area 220 (S305).

The robot 620 may move between the vertiport zone 200 and another zone and carry cargo in each zone or between zones. Another zone may be the complex zone 300 or the supplementary zone 400. The robot 620 may be equipped with an arm for carrying cargo. Apart from carrying cargo, the robot 620 may be equipped with a module for performing at least one of maintenance and/or charging. The robot 620 may transmit a progress, a result and a current location, which are associated with the above-described processing, to the managing device 500. The carrier 630 may transport a passenger using the aerial mobility device 600 to the vertiport zone 200 or another zone by moving between the vertiport zone 200 and another zone.

If processing requested by the managing device 500 is completed, the robot 620 and the carrier 630 may be controlled to stay in the storage area 220, and the storage area 220 may be provided in separation from a designated area of the aerial mobility device 600.

The managing device 500 may receive detailed information on at least one of aerial vehicle state information, charge state information, handling information, flight information, and boarding information of the aerial mobility device 600 that is going to land on the vertiport zone 200 (S310).

If the aerial mobility device 500 enters a designated area designated by movement route information, the managing device 500 may control the robot 620 and/or the carrier 630 to make at least one of the robot 620 and the carrier 630 approach the aerial mobility device 600 (S315).

For example, the designated area may be the object board/alight area 210, the waiting area 216 and the charging site 214, and in case the aerial mobility device 600 enters a designated area associated with the detailed information, at least one of the robot 620 and the carrier 630 may approach at least one of the robot 620 and the carrier 630 that moves to the designated area.

Allocation and a movement route of the robot 620 and the carrier 630 supporting the aerial mobility device 600 may be determined based on a degree of congestion caused by the aerial mobility device 600 in the vertiport zone 200. For example, the degree of congestion may be created based on a stop situation of the aerial mobility device 600 and 610 in the vertiport zone 200, turn around time (TAT) thereof, and the like. In case the degree of congestion exceeds a threshold value, the managing device 500 may control, based on the degree of congestion, the robot 620 and/or the carrier 630 to adjust at least one of whether or not to allocate the robot 620 and/or the carrier 630 in the vertiport zone 200, an approaching time, and a movement route.

The managing device 500 may transmit instruction information based on detailed information to at least one of the robot 620 and the carrier 630 and control at least one of the robot 620 and the carrier 630 to perform processing, according to the instruction information, in/associated with the aerial mobility device 600 (S320).

The present disclosure is technically directed to providing a system and method for managing a smart building that maximizes operation processing of an aerial mobility device and also enables the aerial mobility device to establish smooth support and integrated link to a ground mobility device.

The technical problems solved by the present disclosure are not limited to the above described technical problems. Other technical problems that are not described herein should be more clearly understood by a person having ordinary skill in the technical field, to which the present disclosure belongs, from the following description.

According to the present disclosure, a system is provided for managing a smart building for integrated operation of heterogeneous mobility device. The system may comprising: a smart building with a vertiport zone and a complex zone for supporting operation of an aerial mobility device and a ground mobility device; and a managing device equipped with a memory configured to store at least one instruction and at least one processor configured to execute the instruction stored in the memory, wherein the processor is further configured to: establish movement route information of the aerial mobility device in the vertiport zone based on management information associated with management of at least one of a transport object and flight of the aerial mobility device that lands on the vertiport zone, in case that the movement route information is established (e.g., generated, determined, received) and indicates to move to at least one designated area of the vertiport zone and a charging permission condition is satisfied, set the movement route information to have a charging site in the vertiport zone as a layover point and control the aerial mobility device to move to the charging site according to the set movement route information and to be charged, and in case that the movement route information is established to move the aerial mobility device to the complex zone, control the aerial mobility device to move to an exit area of the vertiport zone approaching the complex zone.

According to an example of the system of the present disclosure, controlling of the aerial mobility device to move to the exit area may comprises: in case that the movement route information is established to head to the complex zone and the charging permission condition is satisfied, setting the movement route information to have the charging site as a layover point for charging the aerial mobility device; controlling the aerial mobility device to move to the charging site; and controlling the aerial mobility device to move to the exit area after completion of the charging.

According to an example of the system of the present disclosure, controlling of the aerial mobility device to be charged may comprises: receiving the management information associated with a charge state and an aerial vehicle state from the aerial mobility device that moves to the charging site; controlling the aerial mobility device to be charged in the charging site based on the charge state; and controlling the ground mobility device to perform maintenance of the aerial mobility device in the charging site based on the aerial vehicle state.

According to an example of the system of the present disclosure, the vertiport zone further may include a rotator placed in front of the charging site on a movement route to the charging site, and wherein the moving of the aerial mobility device to the charging site comprises, in response to the aerial mobility device entering the rotator, rotating, by the processor, the aerial mobility device to make a predetermined portion of the aerial mobility device directed to the charging site.

According to an example of the system of the present disclosure, the complex zone is may a zone where at least one of cargo handling and maintenance is performed on the aerial mobility device, and the management information includes handling information associated with the cargo handling, an aerial vehicle state, and a charge state, and wherein the processor is further may configured to: control loading or unloading of the cargo in the complex zone based on the handling information, and control to perform at least one of maintenance and charging of the aerial mobility device in the complex zone based on the aerial vehicle state and the charge state.

According to an example of the system of the present disclosure, the vertiport zone and the complex zone are vertically may arranged, wherein the smart building further includes an elevator that transfers the aerial mobility device between the vertiport zone and the complex zone, wherein the elevator is equipped with a weight measuring module that provides a weight resulting from cargo loaded in the aerial mobility device and a weight distribution, and wherein the processor is further may configured to: in case that the weight distribution dose not satisfy a weight balance, create arrangement information including at least one of cargo arrangement information and passenger arrangement information in order to strike the weight balance, and control, in the designated area, to place at least one of cargo and a passenger in a designated location in the aerial mobility device based on the arrangement information.

According to an example of the system of the present disclosure, the weight distribution is may create to reflect an impact from a plurality of unloading regions according to a flight route and a passenger boarding state associated with an arrangement of seated passengers in the aerial mobility device that is going to take off.

According to an example of the system of the present disclosure, the ground mobility device may include a carrier and a robot that carry a transport object between the vertiport zone and another zone, and the management information includes an aerial vehicle state, a charge state, handling information associated with cargo handling for the aerial mobility device, flight information, and boarding information of a passenger, and wherein the processor is further may configured to: control the robot and the carrier to be parked in a storage zone, receive detailed information on at least one of the aerial vehicle state, the charge state, the handling information, the flight information, and the boarding information of the aerial mobility device that is going to land on the vertiport zone, in response to the aerial mobility device landing and entering the designated area, control at least one of the robot and the carrier to approach the aerial mobility device, and control at least one of the robot and the carrier to perform processing according to instruction information in the aerial mobility device by transmitting instruction information based on the detailed information to at least one of the robot and the carrier.

According to an example of the system of the present disclosure, the processor is further may configured to: control the robot to move to the complex zone where the aerial mobility device stops, and control the robot to perform processing according to instruction information in the aerial mobility device by transmitting the instruction information according to the detailed information to the robot.

According to an example of the system of the present disclosure, in case that a degree of congestion caused by the aerial mobility device in the vertiport zone exceeds a threshold value, the processor is further may configured to control at least one of the robot and the carrier to move in the vertiport zone based on the degree of congestion.

According to another example of the present disclosure, a method is provided for managing a smart building for integrated operation of heterogeneous mobility devices. The smart building may has a vertiport zone and a complex zone for supporting operation of an aerial mobility device and a ground mobility device, and the method may comprises: establishing movement route information of the aerial mobility device in the vertiport zone based on management information associated with management of at least one of a passenger, cargo, and flight of the aerial mobility device that lands on the vertiport zone; in case that the movement route information is established to move to at least one designated area of the vertiport zone and a charging permission condition is satisfied, setting the movement route information to have a charging site in the vertiport zone as a layover point and controlling the aerial mobility device to move to the charging site according to the set movement route information and to be charged; and in case that the movement route information is established to move the aerial mobility device to the complex zone, controlling the aerial mobility device to move to an exit area of the vertiport zone approaching the complex zone.

The features of the present disclosure, which are briefly summarized above, are only examples of aspects or features of the present disclosure and detailed description of the disclosure follows and are not intended to limit the scope of the present disclosure.

The technical problems solved by the present disclosure are not limited to the above mentioned technical problems. Other technical problems solved by the present disclosure, which are not described herein should be more clearly understood by a person having ordinary skill in the art or technical field to which the present disclosure belongs from the following description.

According to the present disclosure, it is possible to provide a system and method for managing a smart building that maximizes operation processing of an aerial mobility device and also enables the aerial mobility device to establish smooth support and integrated link to a ground mobility device.

The effects obtainable from the present disclosure are not limited to the above-mentioned effects. Other effects not mentioned herein should be more clearly understood by those of ordinary skill in the art through the following description.

For example, the processing may be at least one of passenger board/alight, cargo handling, maintenance, and charging. The instruction information may be created based on detailed information that requires the processing.

While the methods of the present disclosure described above are represented as a series of operations for clarity of description, it is not intended to limit the order in which the steps are performed. The steps described above may be performed simultaneously or in different order as necessary. In order to implement the method according to the present disclosure, the described steps may further include different or other steps, may include remaining steps except for some of the steps, or may include other additional steps except for some of the steps.

The various examples of the present disclosure do not disclose a list of all possible combinations and are intended to describe representative aspects of the present disclosure. Aspects or features described in the various examples may be applied independently or in combination of two or more.

Also, or alternatively, various examples of the present disclosure may be implemented in hardware, firmware, software, or a combination thereof. In the case of implementing the present disclosure by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various examples to be executed on an apparatus or a computer, a non-transitory computer-readable medium having such software or commands stored thereon and executable on the apparatus or the computer.

What is claimed is:

1. A system comprising:
a smart building comprising:
a vertiport zone, and
a complex zone configured to support operation of an aerial mobility device, that lands in the vertiport zone, and a ground mobility device; and
a managing device comprising:
at least one processor, and
a memory storing at least one instruction that, when executed by the at least one processor, configures the at least one processor to:
generate, based on management information, movement route information of the aerial mobility device in the vertiport zone, wherein the management information is associated with management of at least one of:
a transport object for transport by the aerial mobility device, or
flight of the aerial mobility device,
based on the movement route information indicating at least one designated area of the vertiport zone and on a charging permission condition being satisfied, set the movement route information to comprise a layover point of a charging site in the vertiport zone and control the aerial mobility device to move to the charging site according to the set movement route information and to be charged, and
based on the movement route information indicating to move the aerial mobility device to the complex zone, control the aerial mobility device to move to an exit area, of the vertiport zone, approaching the complex zone.

2. The system of claim 1, wherein the at least one instruction, when executed by the at least one processor, configures the at least one processor to control of the aerial mobility device to move to the exit area by:
setting, based on the charging permission condition being satisfied, the movement route information to comprise the charging site as a layover point for charging the aerial mobility device;
controlling the aerial mobility device to move to the charging site; and
controlling the aerial mobility device to move to the exit area after completion of the charging.

3. The system of claim 1, wherein the at least one instruction, when executed by the at least one processor, configures the at least one processor to control the aerial mobility device to be charged by:
receiving, from the aerial mobility device, the management information associated with a charge state and an aerial vehicle state;
controlling, based on the charge state, the aerial mobility device to be charged in the charging site; and
controlling, based on the aerial vehicle state, the ground mobility device to perform maintenance of the aerial mobility device in the charging site.

4. The system of claim 1, wherein the vertiport zone further comprises a rotator placed in front of the charging site on a movement route to the charging site, and
wherein the at least one instruction, when executed by the at least one processor, configures the at least one processor to control the aerial mobility device to move to the charging site by, based on the aerial mobility device entering the rotator, rotating the aerial mobility device to make a predetermined portion of the aerial mobility device directed to the charging site.

5. The system of claim 1, wherein the complex zone comprises a zone configured for at least one of cargo handling or maintenance of the aerial mobility device, and the management information comprises at least one of:
handling information associated with the cargo handling;
an aerial vehicle state; or
a charge state; and
wherein the at least one instruction, when executed by the at least one processor, further configures the at least one processor to:
control, based on the handling information, loading or unloading of the cargo in the complex zone, and
control, based on the aerial vehicle state and the charge state, performance of at least one of maintenance or charging of the aerial mobility device in the complex zone.

6. The system of claim 1, wherein the vertiport zone and the complex zone are vertically arranged;
wherein the smart building further comprises an elevator configured to transfer the aerial mobility device between the vertiport zone and the complex zone;
wherein the elevator is equipped with a weight measurement device configured to acquire a weight measurement of cargo loaded in the aerial mobility device and a weight distribution associated with the aerial mobility device; and
wherein the at least one instruction, when executed by the at least one processor, further configures the at least one processor to:
based on the weight distribution not satisfying a weight balance, create arrangement information configured to cause the weight distribution to satisfy the weight balance, wherein the arrangement information comprises at least one of cargo arrangement information or passenger arrangement information; and
cause, based on the arrangement information and in the at least one designated area, placement of at least one of cargo or a passenger in a designated location in the aerial mobility device.

7. The system of claim 6, wherein the at least one instruction, when executed by the at least one processor, further configures the at least one processor to create the arrangement information to cause the weight distribution to reflect at least one of:
a plurality of unloading regions associated with a flight route of the aerial mobility device, or
a passenger boarding state associated with an arrangement of seated passengers in the aerial mobility device.

8. The system of claim 1, wherein the ground mobility device comprises a robot and a carrier configured to carry a transport object between the vertiport zone and another zone, and the management information comprises at least one of an aerial vehicle state, a charge state, handling information associated with cargo handling for the aerial mobility device, flight information, or boarding information of a passenger; and
wherein the at least one instruction, when executed by the at least one processor, further configures the at least one processor to:
control the robot and the carrier to be parked in a storage zone,
receive information about at least one of the aerial vehicle state, the charge state, the handling information, the flight information, or the boarding information of the aerial mobility device,
based on the aerial mobility device entering the designated area, control at least one of the robot or the carrier to approach the aerial mobility device, and
sending an instruction, based on the received information and to at least one of the robot or the carrier, configured to control the at least one of the robot or the carrier to perform processing associated with the received information.

9. The system of claim 8, wherein the at least one instruction, when executed by the at least one processor, further configures the at least one processor to:
control the robot to move to the complex zone comprising the aerial mobility device; and
send, to the robot, the instruction configured to control the robot to perform the processing.

10. The system of claim 8, wherein the at least one instruction, when executed by the at least one processor, further configures the at least one processor to, based on a degree of congestion caused by the aerial mobility device in the vertiport zone exceeding a threshold value, control at least one of the robot or the carrier to move, based on the degree of congestion, in the vertiport zone.

11. A method for managing a smart building comprising:
a vertiport zone, and
a complex zone configured to support operation of an aerial mobility device and a ground mobility device,
wherein the method comprises:
generating, based on management information, movement route information of the aerial mobility device in the vertiport zone, wherein the management information is associated with management of at least one of:
a transport object for transport by the aerial mobility device, or
flight of the aerial mobility device;
based on the movement route information indicating at least one designated area of the vertiport zone and on a charging permission condition being satisfied, setting the movement route information to comprise a layover point of a charging site in the vertiport zone and controlling the aerial mobility device to move to the charging site according to the set movement route information and to be charged; and
based on the movement route information indicating to move the aerial mobility device to the complex zone, controlling the aerial mobility device to move to an exit area, of the vertiport zone, approaching the complex zone.

12. The method of claim 11, wherein the controlling of the aerial mobility device to move to the exit area comprises:
setting, based on the charging permission condition being satisfied, the movement route information to comprise the charging site as a layover point for charging the aerial mobility device;
controlling the aerial mobility device to move to the second charging site; and
controlling the aerial mobility device to move to the exit area after completion of the charging.

13. The method of claim 11, wherein the controlling of the aerial mobility device to be charged comprises:
receiving, from the aerial mobility device, the management information associated with a charge state and an aerial vehicle state;
controlling, based on the charge state, the aerial mobility device to be charged in the charging site; and
controlling, based on the aerial vehicle state, the ground mobility device to perform maintenance of the aerial mobility device in the charging site.

14. The method of claim 11, wherein the vertiport zone further comprises a rotator placed in front of the charging site on a movement route to the charging site, and
wherein the controlling the aerial mobility device to move to the charging site comprises, rotating, based on the aerial mobility device entering the rotator, the aerial mobility device to make a predetermined portion of the aerial mobility device directed to the charging site.

15. The method of claim 11, wherein the complex zone comprises a zone configured for at least one of cargo handling and maintenance of the aerial mobility device, and the management information comprises at least one of:
handling information associated with the cargo handling;
an aerial vehicle state; or
a charge state; and
wherein the method further comprises:
after the controlling of the aerial mobility device to move to the exit area, controlling, based on the handling information, loading or unloading of the cargo in the complex zone; and
controlling, based on at least one of the aerial vehicle state or the charge state, performance of at least one of maintenance or charging of the aerial mobility device in the complex zone.

16. The method of claim 11, wherein the vertiport zone and the complex zone are vertically arranged,
wherein the smart building further comprises an elevator configured to transfer the aerial mobility device between the vertiport zone and the complex zone,
wherein the elevator is equipped with a weight measurement device configured to acquire a weight measurement of cargo loaded in the aerial mobility device and a weight distribution associated with the aerial mobility device, and
wherein the method further comprises:
based on the weight distribution not satisfying a weight balance, creating arrangement information configured to cause the weight distribution to satisfy the weight balance, wherein the arrangement information comprises at least one of cargo arrangement information or passenger arrangement information; and
cause, based on the arrangement information, placement of at least one of cargo or a passenger in a designated location in the aerial mobility device.

17. The method of claim 16, wherein the creating the arrangement information causes the weight distribution to reflect at least one of:
a plurality of unloading regions associated with a flight route of the aerial mobility device, or
a passenger boarding state associated with an arrangement of seated passengers in the aerial mobility device.

18. The method of claim 11, wherein the ground mobility device comprises a robot and a carrier configured to carry a transport object between the vertiport zone and another zone, and the management information comprises at least one of an aerial vehicle state, a charge state, handling information associated with cargo handling for the aerial mobility device, flight information, or boarding information of a passenger; and
wherein method further comprises:
controlling the robot and the carrier to be parked in a storage zone,
receiving information about at least one of the aerial vehicle state, the charge state, the handling information, the flight information, or the boarding information;
based on the aerial mobility device entering the designated area, controlling at least one of the robot or the carrier to approach the aerial mobility device; and
sending an instruction, based on the received information and to at least one of the robot or the carrier, configured to control the at least one of the robot or the carrier to perform processing associated with the received information.

19. The method of claim 18, further comprising:
controlling the robot to move to the complex zone comprising the aerial mobility device; and
sending, to the robot, the instruction configured to control the robot to perform the processing.

20. The method of claim 18, further comprising, based on a degree of congestion caused by the aerial mobility device in the vertiport zone exceeding a threshold value, controlling at least one of the robot or the carrier to move, based on the degree of congestion, in the vertiport zone.
